(19) United States
(12) Patent Application Publication
(10) Pub. No.: US 2004/0181615 A1
(43) Pub. Date: Sep. 16, 2004

(54) Page printer control apparatus

(75) Inventor: Masaki Masubuchi, Ibaraki (JP)

Correspondence Address: MCGINN & GIBB, PLLC, 8321 OLD COURTHOUSE ROAD, SUITE 200, VIENNA, VA, 22182-3817, US

(73) Assignee: Hitachi Printing Solutions, Ltd., Tokyo (JP)

(21) Appl. No.: 10/793,825

(22) Filed: Mar. 8, 2004

(30) Foreign Application Priority Data
Mar. 12, 2003 (JP) P. 2003-066038

(51) Int. Cl. G06F 3/00

(52) U.S. Cl. 710/8

(57) ABSTRACT

A page printer control apparatus includes a first interface section, a bus, a bridge device, a main memory for storing print data received from a host through the first interface section, the bus and the bridge device, a processing unit for converting the print data into page image data, a second interface section for transmitting the page image data to a printer mechanism, a first PCI bus for connecting the first interface section and the bridge device each other, a second PCI bus for connecting the bridge device and the second interface section each other, a data compression device for compressing data to be transmitted from the bridge device to the second interface section, and a data expansion device for expanding the data transmitted from the bridge device at the second interface section.

### BACKGROUND OF THE INVENTION

1. Field of the Invention

The present invention relates to a page printer control apparatus and particularly to a page printer control apparatus improved in data transfer capability in the inside of the apparatus.

2. Background Art

First, a page printer control apparatus according to the related art will be described with reference to FIG. 3. As shown in FIG. 3, the page printer control apparatus includes a central processing unit (hereinafter abbreviated to CPU) 1, a bridge device 2, a main memory 3, a local bus 4, a host interface (hereinafter abbreviated to host I/F) 5, a disk controller 6, a hard disk 7, and a printer interface (hereinafter abbreviated to printer I/F) 8.

The bridge device 2 is a device which takes a leading part in transferring data in the page printer control apparatus. All data transfers are made via the bridge device 2. The hard disk 7 is primarily used for the purpose of saving various kinds of data. Depending on the apparatus, a control program may be also saved in the hard disk 7.

A flow of data will be described below schematically. Print data transmitted in the form of a page description language or the like from a host (not shown) such as a personal computer are received by the host I/F 5. The print data received by the host I/F 5 are temporarily stored in the main memory 3 through the local bus 4 and the bridge device 2. The stored print data are processed by the CPU 1 to generate page image data (bitmapped image data on a page-by-page basis) which are temporarily stored in the main memory 3. The page image data stored in the main memory 3 are read out by the printer I/F 8 through the local bus 4 and the bridge device 2 and transmitted to a printer mechanical section (not shown) to be printed.

The page image data in the main memory 3 may be also read out by the disk controller 6 through the local bus 4 and stored in the hard disk 7 for the purpose of data saving or the like. To print the page image data saved in the hard disk 7, the saved page image data are first read out by the disk controller 6 and then temporarily stored in the main memory 3 through the local bus 4. Thereafter, the data are read out by the printer I/F 8 through the local bus 4 and transmitted to the printer mechanical section in the same manner as described above.

Several proposals have been made to improve the efficiency of data transfer in the inside of the apparatus according to the related art.

For example, the apparatus described in JP-A-2000-172630 aims at elimination of free time of a bus, and has a configuration in which an ASIC is used for isolating a local bus to achieve this aim.

In the apparatus, bus free time is eliminated by “not freeing the bus” to thereby achieve improvement in transfer efficiency in transferring page image data. The specifications of the local bus must be however specialized for this purpose. There is a problem that the specifications of the bus lack versatility. When a versatile standardized bus, e.g., a PCI bus particularly frequently used in recent years, can be used as a local bus, PCI bus-compliant devices available on the market can be used as elements to be connected to the bus, e.g., the host I/F 5 and the disk controller 6 in FIG. 3 to attain improvement in efficiency at the time of development. According to the method described in JP-A-2000-172630, however, since the specifications of the bus must be specialized, all of the elements to be connected to the bus and hence an LSI for controlling the bus must be developed uniquely, which necessitates a great amount of time and cost for the development of the apparatus as a whole.

In the apparatus described in JP-A-06-191101, JP-A-2001-157062 and JP-A-2002-36639, measures are taken to use data compression and data expansion devices for minimizing the amount of data transferred on a local bus.

In any of the apparatus described in JP-A-06-191101, JP-A-2001-157062 and JP-A-2002-36639, the local bus is however provided in the form of a single common bus. For this reason, all elements to be connected are concentrated on the single bus, so that traffic congestion of data transfer cannot be avoided. Even though data were compressed, such a situation may occur that the total data transfer rate exceeds the transfer rate of the common bus, for example, in the case where all of the elements simultaneously attempt to perform data transfer. The apparatus cannot properly respond to such a situation, so that the efficiency of data transfer maybe reduced consequently.

### SUMMARY OF THE INVENTION

It is an object of the invention to provide a page printer control apparatus that is free from the disadvantages and problems.

Specifically, the object of the invention is to provide a page printer control apparatus in which a versatile standardized bus can be used as a local bus, versatile devices available on the market can be used as elements to be connected to the bus, and the efficiency of data transfer can be improved greatly.

To achieve the foregoing object, the invention provides a page printer control apparatus for storing print data received from a host in a main memory through a first interface section, a bus and a bridge device, converting the print data into page image data and transmitting the page image data to a printer mechanism section through the bridge device, a bus and a second interface section, wherein the first interface section and the bridge device are connected to each other by a first PCI bus, the bridge device and the second interface section are connected to each other by a second PCI bus, and the page printer control apparatus includes a data compression device for compressing data transmitted from the bridge device to the second interface section, and a data expansion device for expanding the data at the second interface section.

Preferably, in the invention, a disk controller and a hard disk are connected to the first PCI bus so that compressed image data stored in the main memory can be temporarily stored in the hard disk.

Preferably, in the invention, a process of transmitting compressed image data from the main memory to the second interface section through the bridge device and the second PCI bus and a process of storing print data in the main memory from the first interface section through the first PCI bus and the bridge device are performed concurrently.

Other features and advantages will be understood clearly from the following description.

### BRIEF DESCRIPTION OF THE DRAWINGS

The present invention may be more readily described with reference to the accompanying drawings:

FIG. 1 is a block diagram showing a configuration of a page printer control apparatus according to an embodiment of the invention.

FIG. 2 is a schematic view for illustrating data transfers in the apparatus according to the invention.

FIG. 3 is a block diagram showing a configuration of a page printer control apparatus according to the related art.

### DETAILED DESCRIPTION OF THE PREFERRED EMBODIMENTS

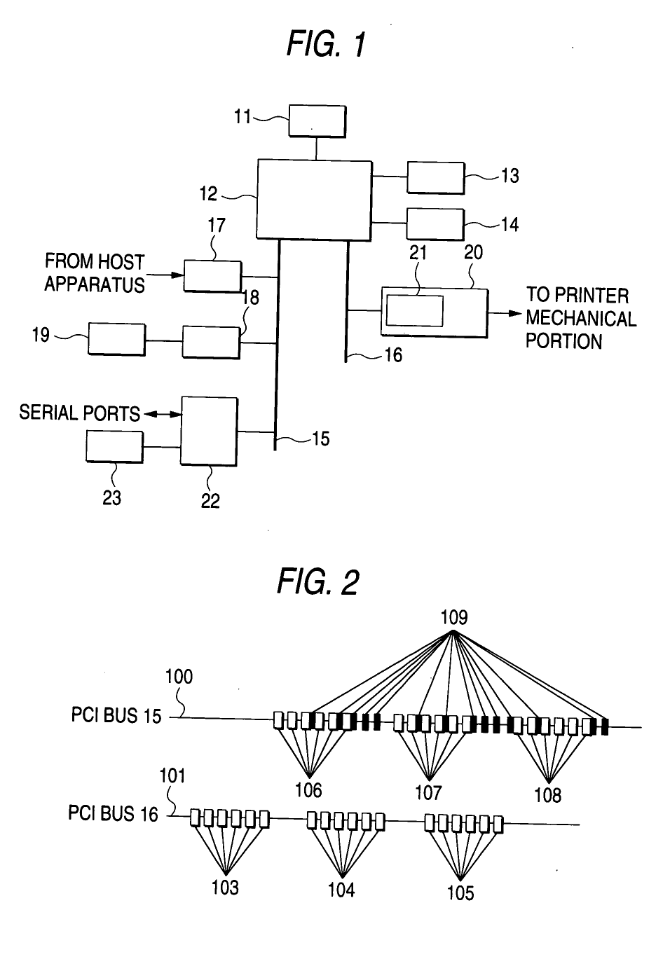

An embodiment of the invention will be described below with reference to FIG. 1.

As shown in FIG. 1, a page printer control apparatus includes a CPU 11, a bridge device 12, a main memory 13, a data compression device 14, PCI buses 15 and 16, a host I/F 17, a disk controller 18, a hard disk 19, a printer I/F 20, a data expansion device 21, an I/O controller 22, and an operation panel 23. The data expansion device 21 is incorporated in the printer I/F 20. The I/O controller 22 has two serial ports. The operation panel 23 is connected to one of the serial ports. For example, the other serial port is used as a communication port for maintenance of the apparatus.

As described above, the page printer control apparatus according to the invention is configured so that two PCI buses each of which is a standardized bus are provided as local buses to improve the data transfer capability of the local buses 15 and 16. Further, the data compression device 14 and the data expansion device 21 are used for compressing page image data transferred on the local buses 15 and 16 to reduce the amount of transferred data to thereby attain improvement in the data transfer capability of the page printer control apparatus as a whole.

A flow of data in the apparatus according to the invention will be described below.

Print data transferred in the form of a page description language or the like from a host such as a personal computer are received by the host I/F 17. The received print data are temporarily stored in the main memory 13 through the PCI bus 15 and the bridge device 12. In this operation, the data are transferred from the host I/F 17 acting as a master to the bridge device 12 acting as a target on the PCI bus 15, so that the data are stored in the main memory 13 by the bridge device 12.

The print data stored in the main memory 13 are processed by the CPU 11 to generate page image data which are temporarily stored in the main memory 13 again. The page image data temporarily stored in the main memory 13 are compressed by the data compression device 14 and temporarily stored in the main memory 13 (hereinafter compressed page image data are referred to as “compressed image data”). The data transfer between the main memory 13 and the data compression device 14 in this operation is executed by the bridge device 12.

To perform printing, the compressed image data in the main memory 13 are read out by the printer I/F 20 and transferred to a printer mechanical section (not shown). At this time, the data are expanded by the built-in data expansion device 21 of the printer I/F 20 so as to be restored to the original page image data which are then transmitted to the printer mechanical section. In this operation, the compressed image data are read out from the main memory 13 in the condition that the printer I/F 20 and the bridge device 12 act as a master and a target, respectively, on the PCI bus 16.

In the ordinary case, the compressed image data stored in the main memory 13 and used for printing are deleted as the printing is completed. In the case where a multi-copy printing function (for printing of plural copies of the same printed material) is used, the compressed image data which have been already printed are temporarily stored in the hard disk 19 before they are deleted. In this case, in the condition that the disk controller 18 and the bridge device 12 act as a master and a target, respectively, on the PCI bus 15, the compressed image data are read out from the main memory 13 and sequentially written in the hard disk 19 by the disk controller 18.

The data transfer load on the buses in the apparatus is maximized when the multi-copy printing operation is being executed. The outline of data transfers on the PCI buses 15 and 16 in this embodiment in this case will be described below with reference to FIG. 2.

In FIG. 2, the reference numeral 100 designates data transfers on the PCI bus 15 shown in FIG. 1; and 101, data transfers on the PCI bus 16 shown in FIG. 1. In FIG. 2, the reference numeral 103 designates data transfers by which the printer I/F 20 reads out compressed image data for an n-th page from the main memory 13 in order to perform printing; 104, like data transfers for an (n+1)-th page; and 105, like data transfers for an (n+2)-th page. Similarly, the reference numeral 106 designates data transfers by which the disk controller 18 reads out the compressed image data for the n-th page from the main memory 13 in order to write the compressed image data in the hard disk 19; 107, like data transfers for the (n+1)-th page; and 108, like data transfers for the (n+2)-th page. The reference numeral 109 designates other data transfers such as data transfers by which the host I/F 17 writes print data received from a host apparatus in the main memory 13 and data transfers resulting from data communication of the I/O controller 22 with the operation panel 23 and the serial ports.

As shown in FIG. 2, each of the compressed image data 103, 104, 105, 106, 107, and 108 for the respective pages on the PCI buses 15 and 16 is divided into small pieces when transferred. In the meantime, the data transfers 109 such as data transfers to allow the host I/F 17 to write print data received from a host apparatus in the main memory 13 and data transfers resulting from data communication of the I/O controller 22 with the operation panel 23 and the serial ports are performed on the PCI bus 16 as occasions demand.

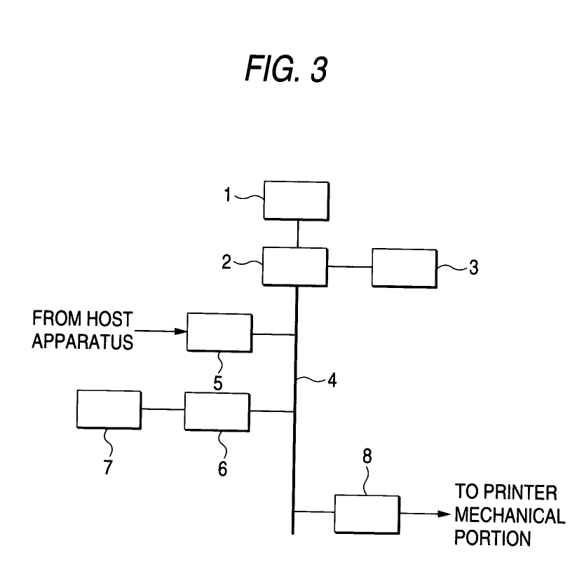

As is obvious from FIG. 2, if the data transfers on the PCI buses 15 and 16 are performed on a single PCI bus as in the related-art apparatus shown in FIG. 3, there is a possibility that the data transfers may not be completed within a required time because the bus activity ratio becomes so high that the bus cannot act in its capacity. The invention eliminates such a problem.

As shown in FIG. 2, in the embodiment of the invention, the data transfers 103, 104 and 105 by which the printer I/F 20 reads out compressed image data from the main memory 13 to perform printing are executed on the independent PCI bus 16. Accordingly, the data transfers can be executed with room for the PCI buses 15 and 16 to act in their transfer capacities. In particular, if the data transfers 103, 104 and 105 on the PCI bus 16 stagnate just a little, this stagnation results in reduction in printing speed immediately. In this embodiment, such reduction in printing speed can be however prevented from being caused by the stagnation of the data transfers because the PCI bus 16 is used exclusively.

As described above, according to the invention, a configuration is adopted in which two PCI buses are used as local buses and in which a data compressing device and a data expansion device are used for compressing page image data transferred on the PCI buses so that data transfer capability in a page printer control apparatus can be improved.

What is claimed is:

1. A page printer control apparatus, comprising:
a first interface section;
a bus;
a bridge device;
a main memory for storing print data received from a host through the first interface section, the bus and the bridge device;
a processing unit for converting the print data into page image data;
a second interface section for transmitting the page image data to a printer mechanism;
a first PCI bus for connecting the first interface section and the bridge device each other;
a second PCI bus for connecting the bridge device and the second interface section each other;
a data compression device for compressing data to be transmitted from the bridge device to the second interface section; and
a data expansion device for expanding the data transmitted from the bridge device at the second interface section.

2. The page printer control apparatus according to claim 1, further comprising:
a hard disk connected to the first PCI bus, the hard disk for temporarily storing compressed image data stored in the main memory therein; and
a disk controller for controlling the hard disk.

3. The page printer control apparatus according to claim 2, wherein a process of transmitting compressed image data from the main memory to the second interface section through the bridge device and the second PCI bus and a process of storing print data in the main memory from the first interface section through the first PCI bus and the bridge device are performed concurrently.
